(19) United States
(12) Patent Application Publication
(10) Pub. No.: US 2008/0283593 A1
(43) Pub. Date: Nov. 20, 2008

(54) Compromised Account Detection

(75) Inventors: Xu He, Charlotte, NC (US); Jin Wang, Charlotte, NC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: Bank of America Corporation, Charlotte, NC (US)

(21) Appl. No.: 11/750,636

(22) Filed: May 18, 2007

(51) Int. Cl. G06K 5/00; G06Q 40/00

(52) U.S. Cl. 235/380; 705/35

(57) ABSTRACT

Systems and methods are disclosed for identifying a compromised account. A compromised account may be identified by identifying a first unique identifier and associating the unique identifier with a fraud behavior. A second unique identifier may be identified and associated with a fraud behavior as well. The first unique identifier and the second unique identifier may be linked if at least a portion of the fraud behavior of the first unique identifier corresponds to at least a portion of the fraud behavior of the second unique identifier. Information relating to the fraud behavior of the first unique identifier, information relating to the fraud behavior of the second unique identifier, and information relating to the link between the fraud behavior of the first unique identifier and the second unique identifier may be stored in a data file. The first and/or the second unique identifiers may be an Internet protocol address.

### FIELD OF TECHNOLOGY

Aspects of the disclosure relate to identifying a compromised account. More specifically, aspects of the disclosure relate to identifying a perpetrator and the compromised customer account before fraud occurs.

### BACKGROUND

Entities performing electronic commerce, financial institutions, and the like face increasing demand from customers to provide services on a remote-access basis, such as over a computer network, e.g. the Internet or an intranet. To provide these remote-access services, the entities must implement security measures to prevent fraud from occurring. Many perpetrators attempt to access a customer's account and obtain personal information to commit fraud and other financial and identity crimes. Such perpetrators may obtain information like a customer's social security number, personal contact information, and account numbers. The perpetrator may utilize a customer's personal information to withdraw money directly from the customer's account or may use it to obtain additional money or credit lines in the customer's name, such as loans or credit cards. This fraudulent behavior may ruin a customer's credit scores and possibly result in devastating identity theft for which the remedies are difficult, time-consuming, and expensive.

Entities that provide customers with remote access maintain an astute interest to provide security for their customer accounts. By preventing fraud on a customer's account, the financial institution prevents loss to both the customer and the financial institution itself. Many entities that provide customers with remote access devote significant portions of their budgets to prevent and remedy fraudulent activity. For example, many financial institutions will assign personnel to work with customers after a perpetrator has accessed the customer's account and withdrawn money or stolen the customer's identity information. When money has been fraudulently withdrawn from a customer's account, a financial institution may be required to replace money that has been lost by the customer. In this situation, the financial institution may be permitted to pursue filing a criminal or civil action against the perpetrator on behalf of the customer and/or the financial institution. Oftentimes, the perpetrator is not located in the United States nor may the perpetrator be extradited to the United States due to a lack of international treaties between the United States and the country in which the perpetrator is located. A financial institution may find that the high costs associated with pursuing such claims significantly exceeds the amount of the loss. The financial institution may choose to absorb the loss rather than pursue the perpetrators.

A need exists for entities that provide remote access to customers to track and/or identify a perpetrator before the perpetrator causes damage to the customer and/or the entity. Many perpetrators that commandeer a customer's personal information may sell the information to others who are also difficult to locate and identify. They may use such tactics as setting up a virtual private network (VPN) to hide the communication from law enforcement officials. They may also use Botnets that include a large number of compromised computers that each have a dynamic internet protocol (IP) address associated with its connection to a computer network.

Financial institutions have implemented a method of preventing fraud based on compiled information relating to a customer's behavior. This information includes spending habits and trends, travel history, and geographical constraints. Such customer behavioral information is documented by a financial institution and used when an anomaly occurs in the customer's behavior. Oftentimes, the behavioral information will be flagged and a customer service agent at the financial institution will be required to confirm the validity of the purchase with the customer. However, this method is inefficient, time-consuming, and produces a high frequency of false positives. A behavioral analysis requires the financial institution to develop a history with a customer and maintain a large amount of information about a customer. Moreover, behavioral analysis may require a significant dedication of resources and personnel to develop and maintain.

Further, behavioral analysis has a high frequency of producing a false positive for a purchase. For example, a person living in North Carolina may decide to take a vacation to China and purchase an expensive gift. This type of purchase may be considered as potentially fraudulent behavior because it is not consistent with the typical purchases made by the customer. Moreover, the customer may be a new customer and may not have developed a behavioral history with the financial institution. As a result, the financial institution may spend money and resources to determine whether the purchase was in fact fraudulent by contacting the customer and verifying that the purchase was valid. In this case, a false positive would have been generated because the financial institution relied upon a customer's behavior to indicate that a purchase was invalid and needless resources were spent verifying a valid purchase.

Therefore, a method of preventing fraud is needed that is efficient and/or quick in detecting fraudulent behavior at a financial institution. Further, a method of preventing fraud is needed that produces fewer false positives to avoid unnecessary cost to the financial institution.

### BRIEF SUMMARY

Aspects of the present disclosure address one or more of the issues mentioned above by describing a system and method for identifying a compromised account. The following presents a simplified summary of the disclosure in order to provide a basic understanding of some aspects. It is not intended to identify key or critical elements of the invention or to delineate the scope of the invention. The following summary merely presents some concepts of the disclosure in a simplified form as a prelude to the more detailed description provided below.

In one example in accordance with aspects of the disclosure, a method is illustrated for identifying a compromised account including identifying a first unique identifier having a first location on a computer network and associating the first unique identifier with a first fraud behavior. A second unique identifier having a second location on the computer network may be identified and associated with the first fraud behavior. A relationship may be established between the first unique identifier and the second unique identifier based on the first location and the second location. The compromised account may be identified by analyzing of the relationship between the first unique identifier and the second unique identifier.

In another example in accordance with aspects of the disclosure, a computer-readable medium comprises computer-executable instructions to perform a method that receives a fraud behavior that is associated with a first request to access a customer account. A data file may be generated and the fraud behavior may be stored in the data file. Related fraud information that is associated with a customer account may be received and stored in the data file as well. The fraud behavior may be electronically related to the related fraud information. The relationship between the fraud behavior and the related fraud information may be stored in the data file. A user may be alerted that the fraud behavior and the related fraud behavior information are related to the customer account.

In yet another example, a fraud detection system for identifying a compromised customer account is disclosed comprising a computing device, a receiver, and a server that is capable of identifying a compromised customer account. The computing device contains software for creating a data file that may be associated with the customer account. The receiver may receive data and the server may comprise memory that stores computer-executable instructions and a processor for executing the computer-executable instructions. The server may store and execute computer-executable instructions that receive information about a first request for access to a customer account by a perpetrator over a computer network. The data may be stored in the data file that is associated with the customer account. Information about a second request for access to the customer account may be received.

### BRIEF DESCRIPTION OF THE DRAWINGS

The present disclosure is illustrated by way of example and not limited in the accompanying figures in which like reference numerals indicate similar elements and in which:

FIG. 1 illustrates a schematic diagram of a general-purpose digital computing environment in which certain aspects of the present invention may be implemented.

FIG. 2 depicts a fraud detection system for identifying a compromised user account, in accordance with at least one aspect of the invention.

FIG. 3 shows a diagram illustrating a system for identifying a compromised account, according to one aspect of the invention.

FIG. 4 depicts a method of detecting a compromised account, in accordance with aspects of the present invention.

### DETAILED DESCRIPTION

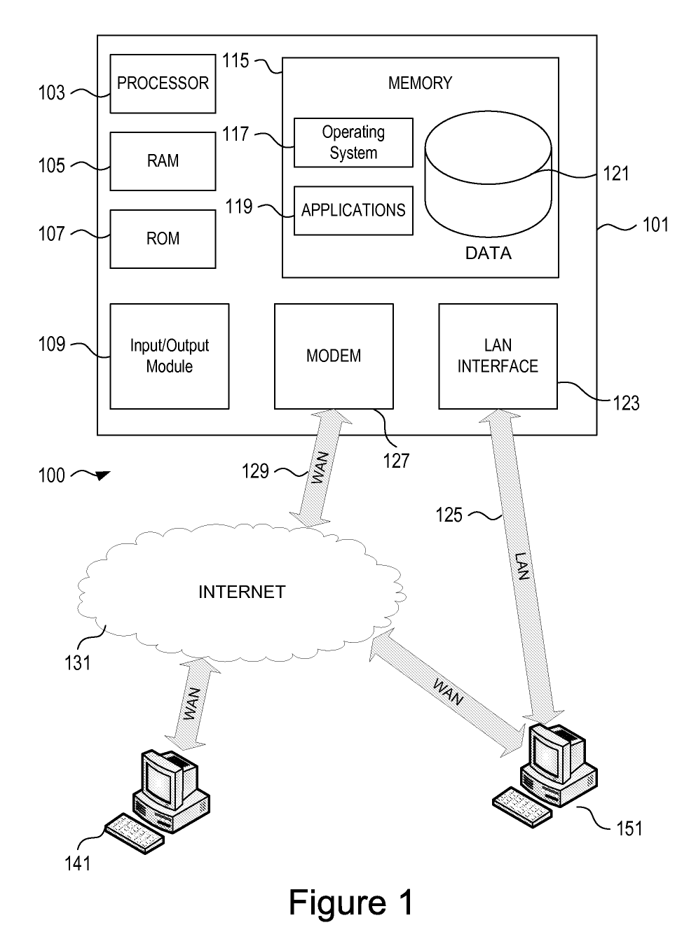

FIG. 1 illustrates an example of a suitable computing system environment 100 that may be used according to one or more illustrative embodiments of the invention. The computing system environment 100 is only one example of a suitable computing environment and is not intended to suggest any limitation as to the scope of use or functionality of the invention. The computing system environment 100 should not be interpreted as having any dependency or requirement relating to any one or combination of components illustrated in the exemplary computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 101. Communication media typically embodies computer readable instructions, data structures, program modules or other data in a modulated data signal such as a carrier wave or other transport mechanism and includes any information delivery media. A modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Although not shown, RAM 105 may include one or more applications representing the application data stored in RAM memory 105 while the computer is on and corresponding software applications (e.g., software tasks) are running on the computer 101.

Input/output module 109 may include a microphone, keypad, touch screen, and/or stylus through which a user of computer 101 may provide input, and may also include one or more of a speaker for providing audio output and a video display device for providing textual, audiovisual, and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated data file 121. Alternatively, some or all of the computer executable instructions for computer 101 may be embodied in hardware or firmware (not shown). As described in detail below, the data file 121 may provide centralized storage of account information, customer information, and fraud information for the entire business, allowing identification of a suspicious or fraudulent customer account, internet protocol address, subnet, or the like.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in FIG. 1 include a local area network (LAN) 125 and a wide area network (WAN) 129 and may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to access web pages from a web-based server. Any of various conventional web browsers can be used to display and manipulate data on web pages.

Additionally, according to an embodiment of the invention, an application program 119 used by the computer 101 may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like.

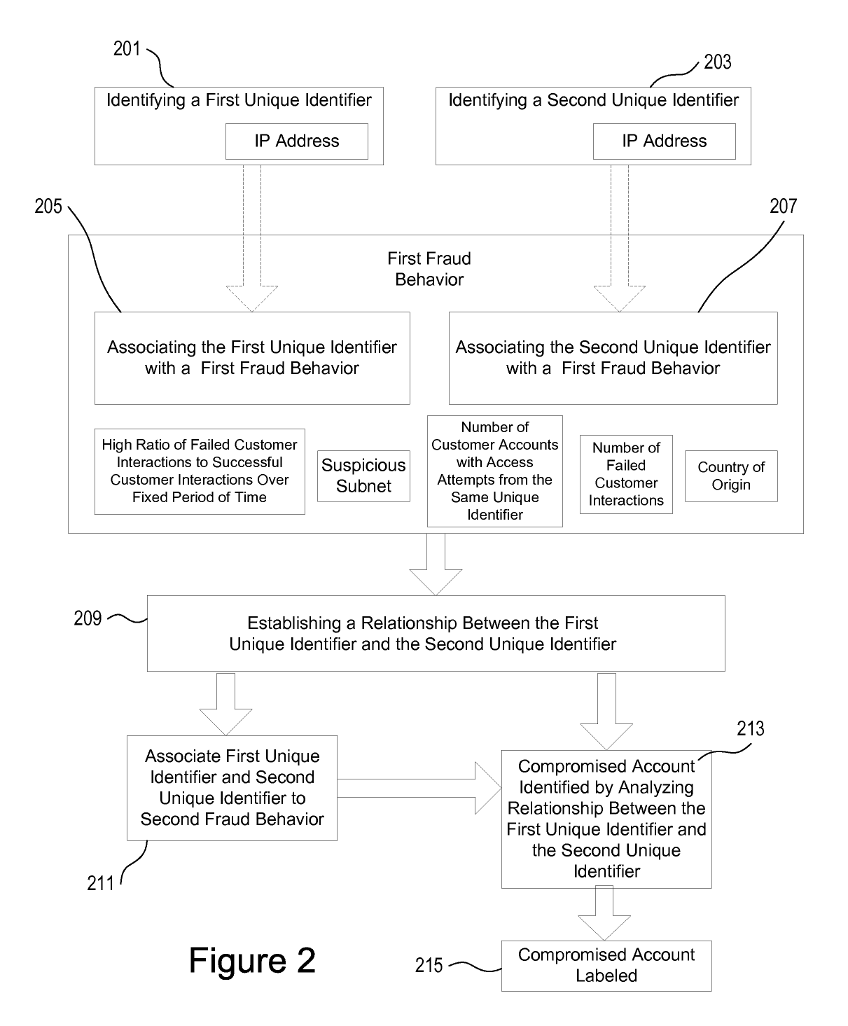

FIG. 2 illustrates a method of identifying a compromised account, in accordance with at least one aspect of the invention. At step 201, the method provides for identifying a first unique identifier having a first location on a computer network. An internet protocol (IP) address may be associated with the first unique identifier. A second unique identifier may be identified at step 203 having a second location on a computer network, and an IP address may be associated with the second unique identifier. In steps 205 and 207, the first unique identifier and the second unique identifier, respectively, are associated with a first fraud behavior. The disclosed method relates the first unique identifier to the second unique identifier in step 209. Optionally, the first fraud behavior and the second fraud behavior may be associated with a second fraud behavior, as disclosed in step 211. The compromised account may then be identified in step 213 wherein a relationship between the first unique identifier and the second unique identifier may be analyzed to identify the compromised account. The relationship may be established based on the first location and the second location. The compromised account may then be labeled as a compromised account in step 215.

A compromised account may be a customer account that has been accessed by a perpetrator or has been labeled as being associated with fraudulent or suspicious activity. A financial institution may maintain a plurality of customer accounts. When fraud or suspicious activity occurs, the financial institution identifies the fraudulent or suspicious account in an attempt to prevent a loss to the customer or the financial institution. A person having ordinary skill in the art will appreciate that the disclosed method of identifying a compromised account may be used on any customer account, especially those accounts that may be remotely accessed.

Oftentimes, financial institutions provide customers with remote access to the customers' accounts over a computer network, described above. The financial institution may provide security for the customers' accounts over the computer network. The security for remotely accessing customer accounts may include a method of detecting fraud prior to the occurrence of the fraud. The financial institution may detect fraudulent or suspicious activity that may be associated with an account, internet protocol address, subnet, or the like. In some instances, the financial institution identifies both fraudulent and suspicious activity and fraud behavior that is associated with a customer's account, an internet protocol address, subnet, or the like.

For example, a customer may maintain a checking account with a financial institution. The financial institution provides the customer with the ability to access the checking account information via a webpage that is accessible through the Internet. To provide adequate security, the financial institution requires that the customer enter a username and password, i.e. “log-in” information. The customer must input the correct username and password or will not be provided remote access to the account. In the event that the customer does not know the username or password assigned to the customer's account, the customer may contact the financial institution to obtain the username or password, but may not be provided remote access to the customer's checking account at that time.

A perpetrator may attempt to intercept the customer's remote access and obtain the log-in information. The perpetrator may use this information to access the customer's account, obtain personal information about the customer, obtain the customer's financial account information, misappropriate money in the customer's account, and the like. Further, a perpetrator may access the customer's account and make unauthorized withdrawals of money from the account. The perpetrator may apply for credit with the customer's personal information and potentially ruin the customer's personal identify, credit history, and credit scores by defaulting on debts. A person having ordinary skill in the art would recognize that a perpetrator may access a customer's account for any reason.

Perpetrators may be located in any geographic location throughout the world and may obtain unauthorized access to the customer's account by accessing the computer network on which the customer's account information may be stored from any location. Oftentimes, the perpetrators may be located in highly suspicious countries including Russia, Ukraine, Lithuania, Estonia, Latvia, Romania, Nigeria, the United Kingdom, the Netherlands, Venezuela, Romania, Indonesia, Egypt, and Israel. One of ordinary skill in the art will appreciate that the geographic location of the perpetrator may frequently change often and the perpetrator's location is not a limitation on the disclosed invention.

Perpetrators may operate from a diverse group of geographical locations. Law enforcement from countries where the fraud occurs may find difficulty in locating and prosecuting the perpetrators. When a perpetrator commits fraud on a customer's account, the customer and/or the financial institution may wish to prosecute the perpetrator. However, without the ability to locate the perpetrator, law enforcement is unable to hold the perpetrator responsible. The financial institution and/or the customer may be forced to absorb the financial loss caused by the perpetrator.

For example, a customer may maintain a bank account in the United States. A perpetrator may attempt to obtain unauthorized access to the bank account from Nigeria. The perpetrator may be successful and obtain unauthorized access to the customer's bank account from Nigeria. The perpetrator may misappropriate all of the funds by committing fraud on the customer's account. The laws of the United States forbid the perpetrator's fraudulent behavior and provide legal remedies on which the financial institution or the customer may recover. However, the United States and Nigeria may not have an international treaty or agreement that requires or encourages Nigeria to assist in identifying or detaining the perpetrator. Even if the perpetrator was identified and detained, Nigeria may not choose to extradite the perpetrator to the United States to be held responsible for the fraudulent behavior. Moreover, Nigerian civil and criminal law may not hold perpetrators of financial crimes responsible for their actions. The Nigerian government may not have sufficient resources to prosecute perpetrators of financial crimes. Further, the current geopolitical climate may prevent foreign countries from cooperating with U.S. law enforcement efforts to punish the perpetrators who commit financial fraud.

A perpetrator may be any entity or program that is capable of accessing a computer network. The perpetrator may be a human being, a group of human beings, a computer program, a computer, a server, or the like. Moreover, the perpetrator may also include a botnet. A botnet is a collection of compromised computers that run common computer programs. The botnet may include a collection of autonomously running software robots and/or a group of networked computers that use distributed computing software. Distributed computing may be a method of performing computer processing in which portions of the software are run on more than one computer (i.e. a group of computers operate together to run a single software program in parallel). A person having ordinary skill in the art will appreciate that the perpetrator is not limited in the present invention and may include any electronic device or user that attempts to obtain unauthorized access to a customer's account.

The method of identifying a compromised account may identify a first unique identifier, as in step 201. The first unique identifier may be an internet protocol address that is associated with the unique location of an electronic device that is coupled to a computer network. For example, a perpetrator may utilize a desktop computer to access the Internet through a computer network to which the desktop computer may be electrically coupled. Both a human perpetrator and an electronic perpetrator may be provided identification information in order to communicate over the computer network. Although the human that is ultimately responsible for the fraud that may occur may not be found, the identification information and/or IP address may be identified. Once identified, the identification information and/or IP address may be associated with a fraud behavior.

The method of identifying a compromised account may also identify a second unique identifier, as in step 203. The second unique identifier may be similar in nature to the first unique identifier. The second unique identifier may be an IP address that is associated with the unique location at which the computer networked is accessed. The second unique identifier may also be associated with a fraud behavior. The first unique identifier and the second unique identifier may be associated with the same fraud behavior or with the same group of fraud behaviors. The first unique identifier and the second unique identifier may also be associated with different fraud behaviors or may be associated with a combination of the same and different fraud behaviors.

Sometimes, the first unique identifier and the second unique identifier are both associated with at least one common fraud behavior. In this case, the first unique identifier and the second unique identifier may be related to each other, as in step 209. Relating the first unique identifier with the second unique identifier may be included in the method of identifying a compromised account.

The first unique identifier and the second unique identifier may be IP addresses, as discussed above. In one aspect of the invention, the first unique identifier and the second unique identifier are the same IP address. When an attempt to access the customer's account is made from the same IP address multiple times, the IP address may be associated with a fraud behavior. The IP address may be identified as suspicious or fraudulent and the customer's account may be identified as compromised.

The fraud behavior may include the country of origin, the number of failed customer interactions, the number of customer accounts that have experienced access attempts from the same unique identifier, the ratio of failed customer interactions to successful customer interactions, presence of a suspicious subnet, and the like. The country of origin may be the country in which the fraud is originating, as described in detail above. In steps 205 and 207 of the method of identifying a compromised account, the first unique identifier may originate in a first country and the second unique identifier may originate in a second country that is different from the first country. For example, a first IP address that attempts to obtain unauthorized access to a customer's account may originate in Venezuela, whereas a second IP address that attempts to obtain unauthorized access to the customer's account may originate in Russia.

The fraud behavior may also include the number of failed customer interactions (FCIs), in steps 205 and 207. Each time an attempt is made to obtain access to the customer's account and the attempt fails, it may be classified as an FCI. The number of FCIs may be documented by the financial institution and may be used to indicate that a customer's account may be compromised. A financial institution may establish a threshold number of FCIs at which the customer's account may automatically be identified as compromised. A person with ordinary skill in the art will recognize that the financial institution may also consider the number of FCIs in any suitable subjective and/or objective manner.

Also in steps 205 and 207, the fraud behavior may include the number of customer accounts that have been accessed from the same unique identifier. The unique identifier may be any identification information that may be associated with a perpetrator. The perpetrator may attempt to access multiple customer accounts from the same unique identifier. For example, a perpetrator may have a first IP address and attempt to access multiple customers' accounts from the same first IP address. When this occurs, the financial institution may label it as fraud behavior. The financial institution may choose to identify one or all of the customers' accounts that have been accessed without authorization as suspicious and/or fraudulent. The fraud behavior may also include the number of customer accounts that have been accessed from related unique identifiers and/or related IP addresses.

The fraud behavior may also include a ratio of the number of FCIs compared to the number of successful customer interactions (SCIs) in steps 205 and 207. The ratio may represent a percentage of SCIs as compared to the number of total customer interactions. The ratio may be continuously updated to include all FCIs and SCIs or may be a ratio that is representative of the FCIs and SCIs that occurred over a fixed period time. The financial institution may perform an analysis of a fixed ratio on a subjective, customer-by-customer basis or may establish a threshold ratio that represents the ratio at which a customer account is identified as suspicious and/or fraudulent. The financial institution may establish a different ratio threshold for a suspicious customer account and a fraudulent customer account.

In steps 205 and 207, the fraud behavior may include the presence of a suspicious subnetwork or “subnet.” A subnet is a portion of the group of unique identifiers that may be associated with a computer network. For example, a range of IP addresses may be assigned to a computer network. Within that range of IP addresses, a first portion of IP addresses may be identified as suspicious and/or fraudulent. A person having ordinary skill in the art will appreciate that the subnet may include a portion of the network layer and associated identifiers (i.e. IP addresses) that may be assigned to a computer network.

A method of identifying a compromised account may include labeling the compromised account as suspicious, also in steps 205 and 207. A financial institution may label the customer account as suspicious either before or after the customer account is identified as being compromised. The financial institution may also label a customer's account as suspicious by identifying one or more fraud behaviors that are associated with the customer's account. A financial institution may alter its definition of a suspicious customer account to meet its needs and may include subjective and/or objective criteria.

Additionally, the method of identifying a compromised account may include labeling the compromised account as fraudulent. A financial institution may label the customer account as fraudulent either before or after it is identified as being compromised. The financial institution may label the customer's account as being fraudulent before or after labeling the customer's account as being suspicious. In some examples, the customer's account is labeled as being fraudulent without being labeled as being suspicious or after being labeled as suspicious.

Additionally, the method of identifying a compromised account may include labeling the unique identifier as fraudulent for a specific amount of time. The amount of time may be any desirable amount of time. For example, the compromised account associated with an IP address or a subnet may be labeled as being fraudulent for one business day, one billing cycle, or the like.

A financial institution may also label a customer account as being fraudulent or compromised. For example, if a customer's account is accessed by a fraudulent unique identifier, then the customer account itself may be labeled as fraudulent. The unique identifier associated with the customer account may be labeled as fraudulent or suspicious and may be associated with an IP address or a subnet. The customer's account may be “flagged” as having been previously accessed by a suspicious or fraudulent IP address or subnet. A financial institution may utilize the information relating to the flagged customer accounts to assist in preventing future fraudulent activity upon the flagged account and upon other unrelated accounts.

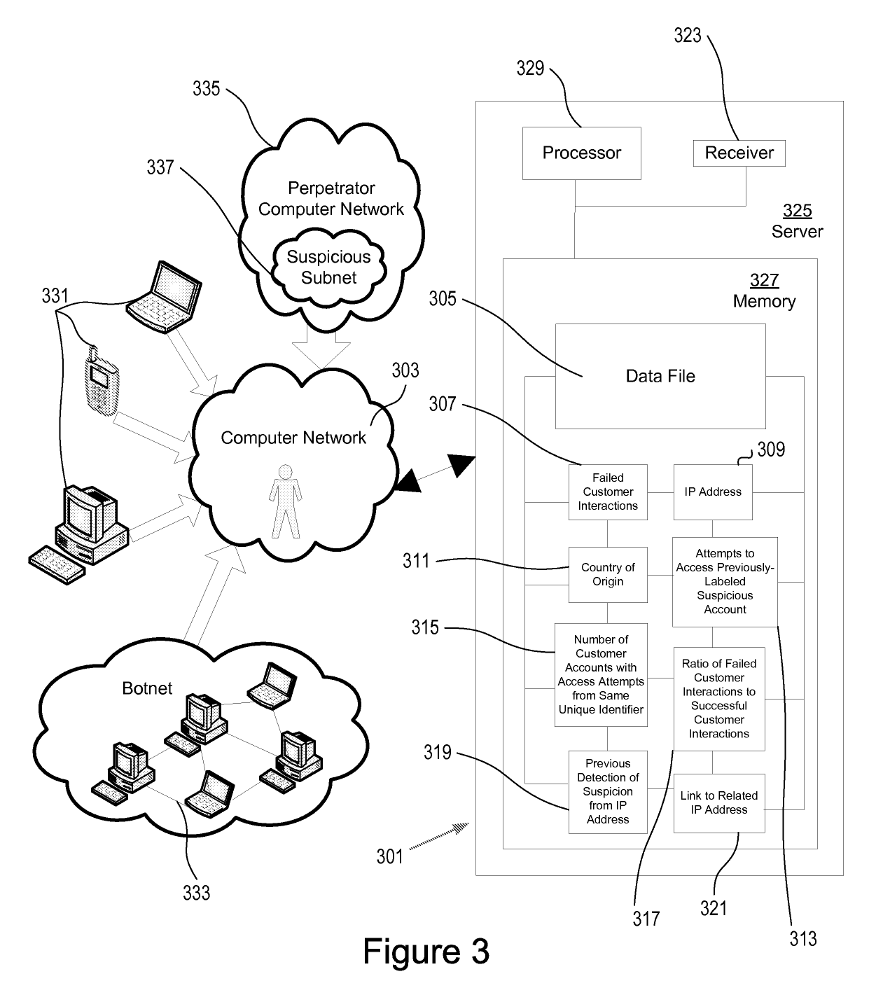

Referring now to FIG. 3, an operating environment for a method of identifying a compromised account is disclosed, in accordance with at least one aspect of the present invention. A financial institution may identify a customer's account as compromised to prevent fraud from occurring and resulting in financial loss to the customer and the financial institution. The financial institution may choose to identify a customer account as being suspicious, fraudulent, or both suspicious and fraudulent. The financial institution may be able to identify a suspicious or fraudulent account and prevent some or all of the financial loss that may occur when a perpetrator obtains unauthorized access to a customer's account.

As illustrated in FIG. 3, a computing device 301 may be coupled to a computer network 303 and may contain software for creating a data file 305. The computing device 301 may be any electronic device that accepts and processes information according to a set of instructions. The computing device may have a user interface that is capable of producing a visual display. The financial institution may identify a compromised customer account by utilizing the software that is contained on the computing devices 301. One of skill in the art will appreciate that more than one computing device 301 may be used.

The computing device 301 may be any electronic device that accepts and processes information according to a set of instructions in the software. The software may be a set of detailed computer-executable instructions for that computing devices 301 may execute. The software provides the computing device 301 with the ability to create a data file 305 and identify a compromised customer account from data that is stored within the data file 305. The data file 305 may contain multiple individual files of information that may each correspond to a group of information. The individual files may include, but are not limited to information relating to the number of failed customer interactions 307, the IP addresses associated with a customer account 309, the country of origin of the IP address 311, the attempts to access a customer account that was previously labeled as suspicious 313, the number of customer accounts that have previous unauthorized access from the same IP address 315, the ratio of FCIs to SCIs 317, the presence of previously detected suspicion from an IP address that is attempting to access the customer's account 319, a link to related IP addresses that have been labeled as either suspicious or fraudulent 321, and the like. These fraud behaviors have been described in detailed above. One of skill in the art will recognize that the fraud behavior may include additional behavior and is not limited to the behaviors described herein.

Referring back to FIG. 3, a receiver 323 may be included in the system for identifying a compromised account, where the receiver 323 receives data that may be stored in the data file 305. The data may be received directly into the data file, or may be processed after being received and then stored in the data file 305. Ultimately, at least a portion of the data (or the resulting data after processing) is received into the data file 305. One of skill in the art will appreciate that the data may contain all information that a financial institution may need to identify a compromised customer account.

The receiver 323 may be any device that is capable of receiving an electrical signal. Moreover, in some examples, the receiver 323 may be a device that is also capable of transmitting the electrical signal from one location to another. For example, a receiver 323 may be input/output (I/O) hardware in a computing device or server that may send and received data and store the data in a data file 305 or send the data to an intermediary element for processing.

In one example in accordance with various aspects of the invention, data may be received by the receiver 323, and may be sent to a server 325. In FIG. 3, a receiver 323 is shown as being included within the server 325. The server 325 may be any shared computer that is operatively coupled to a computer network 303 that acts as a repository and distributor of data. The server 325 may be any shared computing device. Server 325 also may be a fast and robust computing device 301 that acts to organize and regulate data that is being transmitted to the computer network 303. The server 325 may be accessible as a web server over the Internet or an intranet. Furthermore, the server 325 may be embodied as a server farm comprising multiple computers that provide a scaleable and/or secure architecture. One of ordinary skill in the art will appreciate these and other aspects of the server 325 after review of the entire disclosure herein.

The server 325 may include memory 327 for storing computer-executable instructions and a processor 329 for executing computer-executable instructions. The computer-executable instructions may be data in the form of program source code that is capable of modifying the data file 305. The computer-executable instructions may be a series or sequence of instructions for a computing device that are typically in the form of a programming language such as C++, Java, SQL, or the like. A person of ordinary skill in the art will appreciate that various computer programming languages may be used to create the computer-executable instructions, and the invention is not limited to the computer programming languages disclosed herein.

Memory 327 may be a portion of the server 325 that stores data or other instructions for later use. The memory 327 may be retained or lost when power is lost to the system. The processor 329 may be capable of executing the computer-executable instructions. The computer-executable instructions may be executed by the processor 329 after they have been stored in the memory 327. The processor 329 may be a centralized element within a computing system that is capable of performing computations. For example, the processor 329 may perform the computations that are described in the computer-executable instructions and then execute the computer-executable instructions. In accordance with at least one aspect, the computer-executable instructions may include data describing changes to the data file 305 that were made by a user or computing device 301 over the computer network 303.

The data that is stored in the data file 305 may include data related to the fraud behavior associated with a customer account. A first request for access to the customer's account may be received over the computer network from a remote device 331. The data associated with the request may be stored in the data file 305 that is associated with the customer account. Information relating to a second request to the customer account may be received. The computing device 301, the receiver 323, and the server 329 form a fraud detection system that is capable of identifying a compromised customer account.

In an aspect of the invention, a computer-readable medium may comprise computer-executable instructions to perform a method of identifying a compromised customer account. A fraud behavior may be received, wherein the fraud behavior is associated with access to a customer account. The fraud behavior may be received to a receiver that is included in a computing device. The receiver may receive the computer-executable instructions and then send them to a processor to execute. A data file 305 may be generated and the fraud behavior may be stored in the data file 305. Related fraud information may be received that is associated with the customer account and may be stored in the data file 305. The fraud behavior may be electronically related to the related fraud information and may be stored in the data file 305. A user at the financial institution may be alerted that the fraud behavior and the related fraud information are associated with the customer account.

The fraud behavior and the related fraud information may include information relating to an IP address 309 or multiple IP addresses that are associated with unauthorized access to the customer account. Further, the related fraud information may include information relating to a related IP address associated with previous fraud 319, either related to the customer account or related to another customer account. The related fraud information may also include information about previous detection of suspicion that was detected on the customer account or another customer account.

As described in great detail above, the system for identifying a compromised customer account may include attempts to obtain unauthorized access to a customer's account from many remote devices 331. Sometimes, these remote devices 331 may be acting individually and in other circumstances, a group of robot computers may be acting in concert, such as in a botnet 333. A portion of a perpetrator's computer network 335 may also be attempting to obtain unauthorized access to the customer's account, such as in the case of a subnet 337 of a perpetrator computer network 335. The financial institution may label this subnet as a suspicious subnet 337.

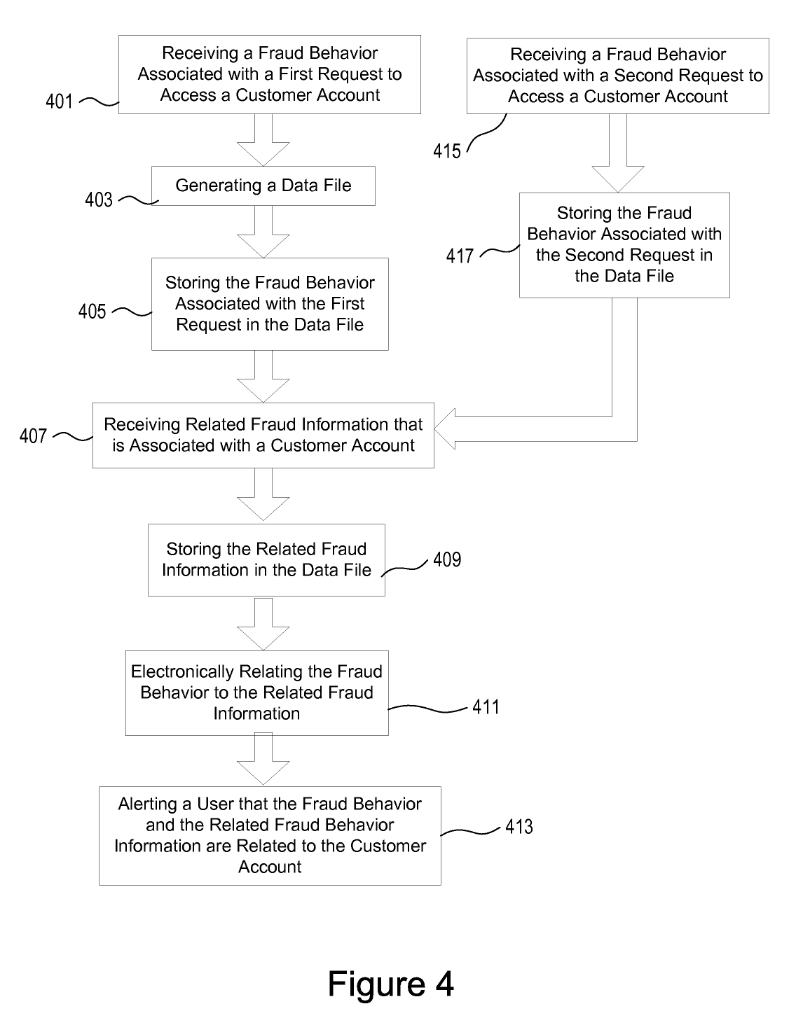

In FIG. 4, a computer-readable medium comprising computer-executable instructions is disclosed. The computer-readable medium performs a method comprising receiving a fraud behavior associated with a request to access a customer account 401. A fraud behavior may be any behavior that a financial institution determines to be fraudulent or suspicious, as described in detail above. A request may be an attempt to access the customer account. A person having ordinary skill in the art will appreciate that a request may be any attempt to access a customer's account, whether the request is authorized or unauthorized. A data file may be generated at step 403 and may provide centralized storage of account information and account holder information for the entire business, allowing interoperability between different elements of the business residing at different physical locations, as described in detail above. The fraud behavior that is associated with the first fraud request may be stored in the data file at step 405. The related fraud information may be received and may be associated with a customer account and any additional information relating to a fraud that has been committed on the customer account at step 407. The related fraud information may be stored in the data file at step 409.

Memory may store data or other instructions for later use, such as computer-executable instructions. The fraud behavior and the related fraud information may be stored in the data file that is stored in the memory at step 405. The fraud behavior and the related fraud information may be electronically related to each other in step 411, wherein the relationship formed between the fraud behavior and the related fraud information may be stored in the data file. One of ordinary skill in the art will recognize that the fraud behavior and the related fraud information may be electronically related in any conceivable manner. At step 413, a user may be alerted that the fraud behavior and the related fraud information are related to the customer account.

Optionally, a fraud behavior that is associated with a second request to access a customer account may also be received at step 415. The second request may then be stored in the data file at step 417. A person having ordinary skill in the art will appreciate that a plurality of requests may be received and stored in the data file.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. Of course, the methods and systems of the above-referenced embodiments may also include other additional elements, steps, computer-executable instructions, or computer-readable data structures. In this regard, other embodiments are disclosed herein that can be partially or wholly implemented on a computer-readable medium, for example, by storing computer-executable instructions or modules, or by utilizing computer-readable data structures.

We claim:

1. A method of identifying a compromised account, comprising:
identifying a first unique identifier having a first location on a computer network;
associating the first unique identifier with a first fraud behavior;
identifying a second unique identifier having a second location on the computer network;
associating the second unique identifier with the first fraud behavior;
establishing a relationship between the first unique identifier and the second unique identifier, a portion of the relationship being based on the first location and the second location; and
identifying the compromised account by analyzing the relationship that is formed over the computer network between the first unique identifier and the second unique identifier.

2. The method of claim 1, wherein the first unique identifier includes an internet protocol address.

3. The method of claim 2, wherein the first fraud behavior includes a plurality of customer accounts, each customer account having at least one access attempt from the same internet protocol address.

4. The method of claim 2, wherein the second unique identifier includes an internet protocol address, and wherein the first unique identifier and the second unique identifier include a same first fraud behavior.

5. The method of claim 1, wherein the second unique identifier is an internet protocol address.

6. The method of claim 1, wherein the first fraud behavior includes a country of origin associated with the first unique identifier.

7. The method of claim 1, wherein the first fraud behavior includes a number of failed customer interactions.

8. The method of claim 1, wherein the first fraud behavior includes a ratio of failed customer interactions to successful customer interactions.

9. The method of claim 1, wherein the first fraud behavior includes a suspicious subnet.

10. The method of claim 1, further comprising labeling the compromised account as suspicious.

11. The method of claim 1, further comprising labeling the compromised account as fraudulent.

12. The method of claim 1, further comprising labeling the internet protocol address as suspicious.

13. The method of claim 1, further comprising labeling the subnet as suspicious.

14. The method of claim 1, further comprising associating the first unique identifier with a second fraud behavior.

15. The method of claim 1, further comprising previously detecting fraud associated with the first unique identifier.

16. A computer-readable medium comprising computer-executable instructions to perform a method, comprising:
receiving a fraud behavior associated with a first request to access a customer account;
generating a data file;
storing the fraud behavior in the data file;
receiving related fraud information that is associated with the customer account;
storing the related fraud information in the data file;
electronically relating the fraud behavior to the related fraud information, wherein the relationship between the fraud behavior and the related fraud information is stored in the data file; and
alerting a user that the fraud behavior and the related fraud information are related to the customer account.

17. The computer-readable medium of claim 16, further comprising identifying an internet protocol address associated with the request.

18. The computer-readable medium of claim 16, further comprising identifying the customer account as suspicious.

19. The computer-readable medium of claim 18, further comprising identifying the customer account as fraudulent.

20. The method of claim 16, further comprising identifying the customer account as fraudulent.

21. The computer-readable medium of claim 16, wherein the fraud behavior includes a number of failed customer interactions.

22. The computer-readable medium of claim 16, wherein the fraud behavior includes a country of origin.

23. The computer-readable medium of claim 16, wherein the fraud behavior includes a ratio of failed customer interactions to successful customer interactions.

24. The computer-readable medium of claim 16, wherein the related fraud information includes information relating to a related internet protocol address.

25. The computer-readable medium of claim 16, wherein the related fraud information includes information about a previous detection of suspicion associated with the customer account.

26. A fraud detection system for identifying a compromised customer account, comprising:
a computing device that contains software for creating a data file associated with a customer account;
a receiver for receiving data; and
a server comprising memory storing computer-executable instructions, and a processor for executing the computer-executable instructions to perform a method, comprising:
receiving information about a first request for access to a customer account from a perpetrator over a computer network;
storing the data in the data file associated with the customer account;
receiving information about a second request for access to the customer account;
wherein the computing device, the receiver, and the server form a fraud detection system that is capable of identifying a compromised customer account.
